(19) United States
(12) Patent Application Publication
(10) Pub. No.: US 2016/0191667 A1
(43) Pub. Date: Jun. 30, 2016

(54) COMMUNICATION PREFERENCES

(71) Applicants: Mrinal Desai, Los Gatos, CA (US); Jorge Ferreira, Sammamish, WA (US)

(72) Inventors: Mrinal Desai, Los Gatos, CA (US); Jorge Ferreira, Sammamish, WA (US)

(21) Appl. No.: 14/304,862

(22) Filed: Jun. 13, 2014

Related U.S. Application Data
(60) Provisional application No. 61/834,811, filed on Jun. 13, 2013.

(51) Int. Cl. H04L 29/08

(52) U.S. Cl. CPC H04L 67/34; H04L 67/18

(57) ABSTRACT

Communication preferences are disclosed. Communication preferences allow a user to be contacted according to specified communication preferences related to one or more communication channels.

### RELATED APPLICATIONS

This application claims the benefit of U.S. Provisional Application No. 61/834,811, filed Jun. 13, 2013, which is incorporated by reference herein for all purposes.

BACKGROUND

1. Field of the Invention

The present invention relates generally to communication preferences, and more specifically to a system and method to manage preferences for inbound communications.

2. Prior Art

A current contact data management approach allows a user to enter and store various types of contact information for multiple contacts. For example, a user of a smart phone may have an electronic address book application that is configured to store a phone number, an email address, a web address, a mailing address or other information related to people in an application that provides simple retrieval or use of the contact information.

Users often have multiple devices and therefore need to synchronize address books across their devices. Currently there are approaches for updating contact information for multiple devices operated by a single user. U.S. Patent Application Publication 2006/0242210, entitled CONTACT MANAGEMENT UPDATE PROTOCOLS, provides a system and method for synchronizing or merging folders managed by an owner or member. However, the approach in the subject publication generates a single static folder that can then be used in multiple locations and therefore is restricted to folders managed by a single user.

### SUMMARY

A system and method for preferred communications are disclosed. One embodiment provides for setting communication preferences to allow remote devices to display preferred communication channels. In this way, communication preferences can be sent to remote devices so a person can be communicated with in a preferred manner. Other embodiments are disclosed in the following detailed description.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example embodiment of a preferred communications system.

FIG. 2 shows an example screen shot of an embodiment system to set communication preferences.

FIG. 3 shows an example screen shot of an embodiment system to schedule communication preferences.

FIG. 4 shows an example screen shot of an embodiment system to set default communication preferences.

FIG. 5 shows an example screen shot of an embodiment system to schedule communication preferences.

FIG. 6 shows an example screen shot of an embodiment system showing a preferred number for a scheduled date range.

FIG. 7 shows an example screen shot of an embodiment system to set communication preferences related to driving.

FIG. 8 shows an example screen shot of an embodiment system to set communication preferences related to battery level.

FIG. 9 shows an example screen shot of an embodiment system to set communication preferences related to the activity level.

FIG. 10 shows an example screen shot of an embodiment system to selectively share contact information.

FIG. 11 shows an example screen shot of a remote system to receive selectively scheduled contact information.

FIG. 12 shows an example screen shot of an embodiment system showing default settings for text and video communication preferences.

FIG. 13 shows an example screen shot of an embodiment system to provide communication preferences through other applications.

FIG. 14 shows an example screen shot of an embodiment system showing preferred and shared communication preferences for text and video.

FIG. 15 shows an example screen shot of a remote system showing a driving preference being selected.

FIG. 16 shows a flow chart of an example method of setting preferred communications.

FIG. 17 shows three cell sizes for an example growing cell embodiment.

### DETAILED DESCRIPTION

The present disclosure describes example embodiments of a preferred communications system and method. Generally, these embodiments allow a user to set preferences for inbound communications through a variety of communications channels or applications. These embodiments provide a way to have communication preferences, status and/or available channels data 180 sent to remote devices, or connected contacts, so a person can be communicated in a user specified manner. For example, a preferred communications system can work on a contact or address book application such as that disclosed in U.S. patent application Ser. No. 13/917,564, related to CONTACT DATA SHARING and incorporated herein by reference in its entirety for all purposes. Other embodiments related to this general concept are also described in the following detailed description. In some embodiments, communication preferences may be sent directly to remote devices, uploaded to one or more servers to be accessed and downloaded by remote devices, pulled from a device by a request from a server or a remote device, etc. Communication preferences may therefore be communicated between contacts directly or indirectly, automatically, by a push or pull data model or by any other suitable model to communicate the preferences between devices or users.

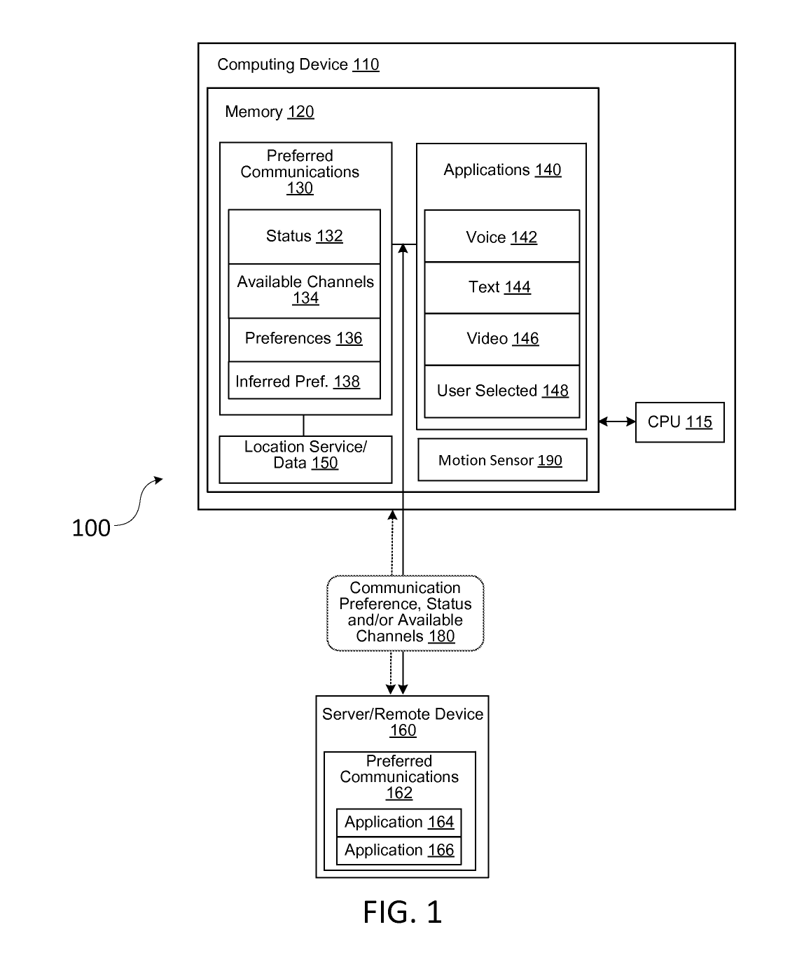

FIG. 1 shows an example embodiment of a preferred communications system 100. System 100 includes a memory 120 and a CPU 115 in communication with memory 120. CPU 115 may be a single processor, multiple processors, multiple cores, etc. Memory 120 includes a preferred communications module 130, application module 140 and a location service/data 150. Preferred communications module 130 includes components for status 132, available channels 134 and preferences 136. In the illustrated embodiment, applications include voice 142, text 144 and video 146 and user selected 148 applications. FIG. 1 also shows a server/remote device 160 including a preferred communications settings 162 and applications 164 and 166.

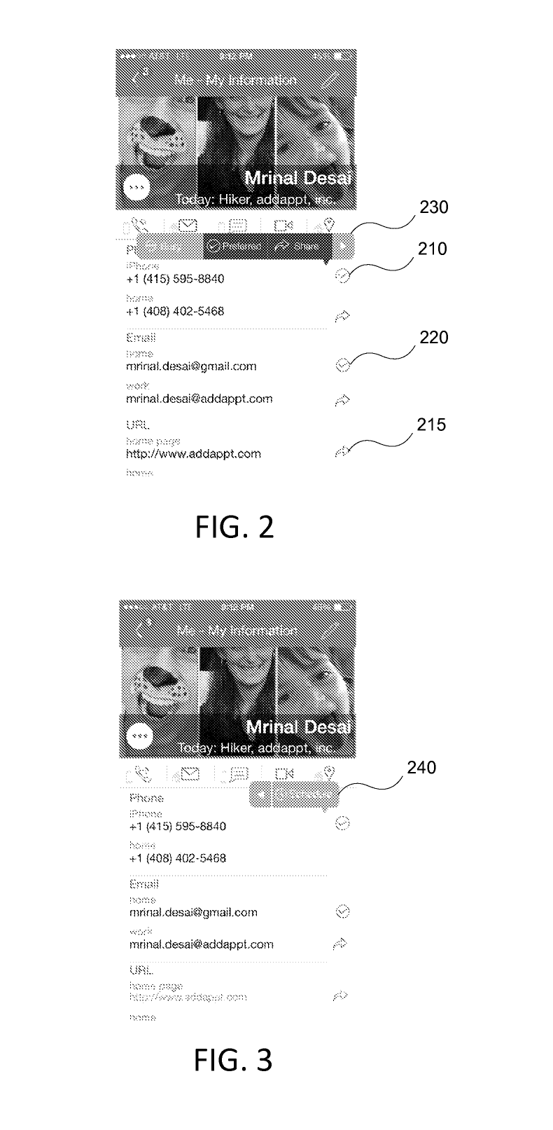

In system 100, status 132 may be set as busy, available over one or more preferred applications, as non-limiting examples. This allows the status of a person in a contact list to be displayed to a user that has that person in their contact list. For example, the person in the contact list may prefer to be contacted on their iPhone 210 or at a home email address 220 as shown in FIG. 2. In this way, the operator of the contact list can view the contact information of the person who specified their preferred communications and the operator of the contact list can contact the person with specified preferred communications through their preferred method of communication. Additionally, status 132 may be set using a context menu 230.

In some embodiments, communication preferences may be automatically set or be an inferred preference 138 based on common channels between contacts or on cost, etc. For example, if two contacts have iPhones a communication preference between them for video apps can be inferred and set to FaceTime while a communication preference for text messaging can be set to iMessages. In another example, if connected contacts have different coverage carriers then their communication preference for text messages can be inferred to be WhatsApp. In this way the communication preference can be automatically set to use a free or less expensive communication channel. In some embodiments, a communication preferences system can suggest using a channel or application that one side of a potential communication does not yet have. For example, if a user does not have WhatsApp and system 100 detects this, then it can recommend to the user without WhatsApp to install it to have cheaper or a free text message communications with the associated contact. In this way communication preferences can include suggestions for communication channels or applications within communication channels that may be suggested to a user. In some embodiments, third party applications such as social networks, VoIP, video applications, etc., may integrate with a communication preferences application and allow the communication preferences application utilize the third party application. For example, if third party applications are signed into or active, or if the login information is stored in the communication preferences application, then the communication preferences application can actively send communications through those communications channels or communicate to a remote device that they may contact a user through those channels, etc.

In another example, in some embodiments a user may use different SIM cards in a phone associated with a contact application and may set communication preferences based on which SIM card is used. For example, a user may have a SIM card they use for travelling in a different carrier network or internationally, and the user can set communication preferences for the different carrier network or international area, time, communication channel, etc. In this way a user can set preferences to automatically use less expensive communication channels, to set their preferences for different time zones, etc.

In some embodiments these inferred preferences 138 can override global set preferences, but other embodiments are not so limited. For example, while communication preferences may be set to inferred, they may also be overridden by a user selected preference. In this way a user may set as global communication preference but also have settings for inferred preferences on some or all of their contacts, and even after a communication preference is inferred they may choose to override the inferred communication preference for one or more contacts and select a different communication preference than the inferred preference or the global preference.

In some embodiments, a global setting could include an unavailable communication preference after 9 PM every day. In this way the user's preference for no or limited communications can be set to remote users who have that person in their contact application and can see their communication preference. In some embodiments the global preference can be overridden or may only apply to some communication channels. For example, the global preference can apply to telephone communications but not email communications. Other embodiments may set global preferences for combinations of communication channels. In some embodiments, phone or device alerts may be adjusted based on global settings or on other communication preferences. In the current example a user set a global preference to be unavailable or away after 9 PM and a preferred communications system may adjust their phone or device alert settings to not show alerts during this time. However other embodiments are not so limited and alerts may be adjusted at other times based on set or inferred communication preferences. Some embodiments may have specific days that may have global settings, such as holidays, anniversaries, birthdays, etc. In this way global settings can be adjusted based on communication channel, based on specific days or a groups of days (even if separated by date), on a combination of factors such as time zone and specific day, location and a holiday, etc.

In some embodiments, a change in status may also be sent as a message or alert to the remote device. For example, if a global setting changes from available to unavailable, or unavailable to available, as example, in addition to updating a remote device contact application, the remote device can display an alert to show the connected contact's status changed. In this way the remote user will not have to view their contact application itself but may see a contact is available or unavailable by the explicit alert. In some embodiments, a preferred communication system 100 can display incoming communications that happened while a person was unavailable, busy, out of office, etc. For example, while a user is listed as unavailable they still may receive attempted communications from one or multiple people. These attempted communications can be shown in an alert in real-time, after their status changes to available, upon other device activity, etc.

With reference back to the embodiment in FIG. 1, context menu 230 includes busy, preferred, share and a right arrow to access other inputs such as a schedule 240 as shown in FIG. 3. With reference to FIG. 9, the mobile (iPhone) phone and work email communication channels are listed as busy and a context menu is shown for the work email allowing a user to select busy, preferred or shared status for that communication channel. In one example of user status, a user may be determined to driving as illustrated in FIG. 7 based on a motion sensor 190 detecting they are moving at a certain rate. In this way preferred communications may exclude calls or texting or may include calls or texting for emergencies or other important communications. Other embodiments may have other preferred communications status selections than those depicted in this disclosure. FIG. 15 shows an example screen shot of a remote system showing a driving preference being selected. In some embodiments, communication preferences shown on a remote device 160 may display the user preferences and allow the remote user to select the preferred communication or an alternate communication. In some embodiments the remote contact application may automatically set the preferred communication so that when the remote user initiates a communication it is over the preferred communication channel automatically. Additionally, remote device 160 may set preferred communications based on a combination of capabilities of computing device 110 and remote device 160. For example, it may not just utilize a preferred communication as set by computing device 110, but may select a separate preference based in part on communication preferences for computing device 160. In some embodiments, a remote device may display a message or pop-up including a contacted user's status, such as “I am busy” or “out of the office”. Additionally, these messages or pop-ups may further include an icon or be used as an input to alert the contact to call, text, email, etc., the remote user when they become available.

In FIG. 1, available channel 134 of preferred communications module 130 may include voice options related to voice application 142, such as plain old telephone service (POTS), Voice over IP (VoIP), Home, Work, Mobile, etc. Additionally, available channel 134 component may text options related to text application 144, such as email, SMS, text applications such as WhatsApp or Kik, as examples, social network messages such as on Facebook, LinkedIn, Twitter direct messaging, etc. Other options in the present embodiment available channel 134 component include video options related to video application 146 such as Tango, Hangout, Skype, FaceTime, etc. and location information from location service/data 150 which allows a user to specify their availability at home or a work address, as a non-limiting example. In this way status 132 may be set for one or more of the available channels.

With reference to the example in FIG. 2, a user may select preferences 136 to be contacted on their iPhone 210 or at a home email address 220 as shown in FIG. 2 and have a home phone number, work email and URL home page still be shared to contact lists that they are listed in. The settings displayed in FIG. 2 may also be adjusted by context menu 230 to other settings. For example, a user may select their home number as their preferred contact number and list their work email account as busy, or may change settings to share only some of their contact information. For example, in one use case a user may be traveling and have a new local number, address, texting service or video chat service during their time traveling. FIG. 9 shows another example screen shot of an embodiment system to selectively share contact information.

In another use case, a user may select preferred communications based on cost. For example, a user can set a preference 136 for communications through a free channel as opposed to a carrier provided channel such as by using WhatsApp as opposed to carrier provided SMS messaging. In this way, when a user sets the free channel as a preferred communication, a person with that user in their contact list can access their contact list and see the user prefers to be texted through WhatsApp. As another example, a user may select their preferred communication as a VoIP call as opposed to a phone call through their carrier. In another example use case, a user may prefer to receive communications by email as opposed to being called or texted in order to not be interrupted by communications or notifications. In this way, a person accessing their contact list can contact them through email as opposed to a call or a text message and the user can respond asynchronously based on their preference.

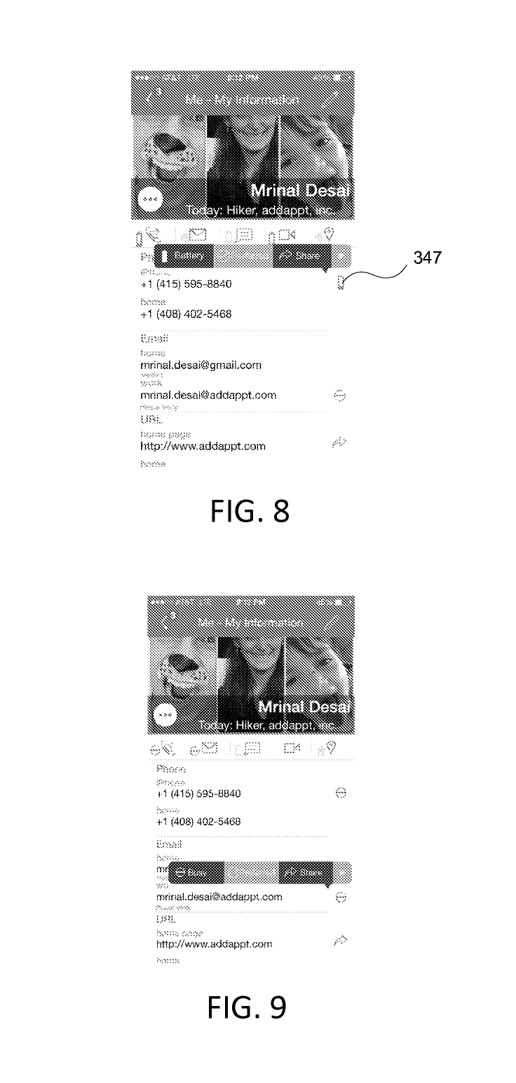

In some embodiments, available channels 134 may also include other information related to communications. For example, when a set or user settable amount of charge is remaining in a battery an icon 347 can be displayed in a remote contact list showing there is limited charge, as illustrated in FIG. 8. In this way a communication may be selected that is less reliant on the battery charge. For example, when a battery charge is running low a text or email may be a preferred communication over a phone call.

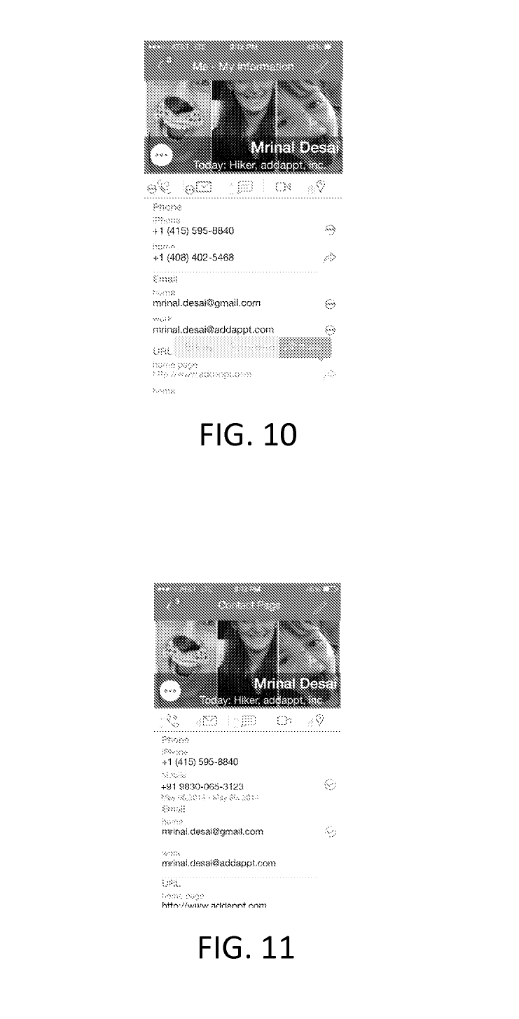

In some embodiments, preferences 136 may be location aware. For example, a location service 150 or location data 150 determined by GPS, cell tower location, etc., may be used to determine if a user is remote from their work location or their home, these communication channels may be listed as busy, unavailable, or otherwise not listed as preferred. In this way they may be contacted on a channel they are more likely to receive a communication on. FIG. 10 shows another example screen shot of a remote system to receive selectively scheduled contact information.

In yet another embodiment, preferences 136 may be set based on a time zone, time of day, etc. For example, a user may set a communication preference as their work phone or work email during regular business hours within their primary time zone and their home or mobile phone number or personal email during non-work hours. Another example would allow a user to set a communication preference for their work phone or work email during other hours if they are in a different time zone than their primary time zone. In this way a user may set their work phone and work email as preferred communications during working hours in the time zone they are in as opposed to their primary time zone, by way of example. In some embodiments, a remote device user interface can be adjusted to communicate communication preferences. For example, when a user is in a different time zone then a contact page on a remote device may be dark, show a moon, etc., to designate the person the contact relates to may prefer to not be communicated with at that time or may prefer more asynchronous communication channels such as email. In some embodiments this user interface change can be automatic, user selected, etc.

With reference to FIG. 2, context menu buttons for busy, preferred and share may toggle between options. For example, a first selection of the busy button may set that communication channel as busy while a subsequent selection may toggle it back to available. Additionally, the preferred button may toggle between preferred and not listed as preferred by single taps or selections of the button. In similar fashion, a share button may be toggle activated between shared and not shared states by a selection or tap of the share button. In the illustrated embodiment, the right arrow button on the right side of the context menu 230 may open up another menu or additional options on the context menu. For example, FIG. 3 shows a button to schedule 240 communications preferences as can be shown after the right arrow button on the context menu has been selected.

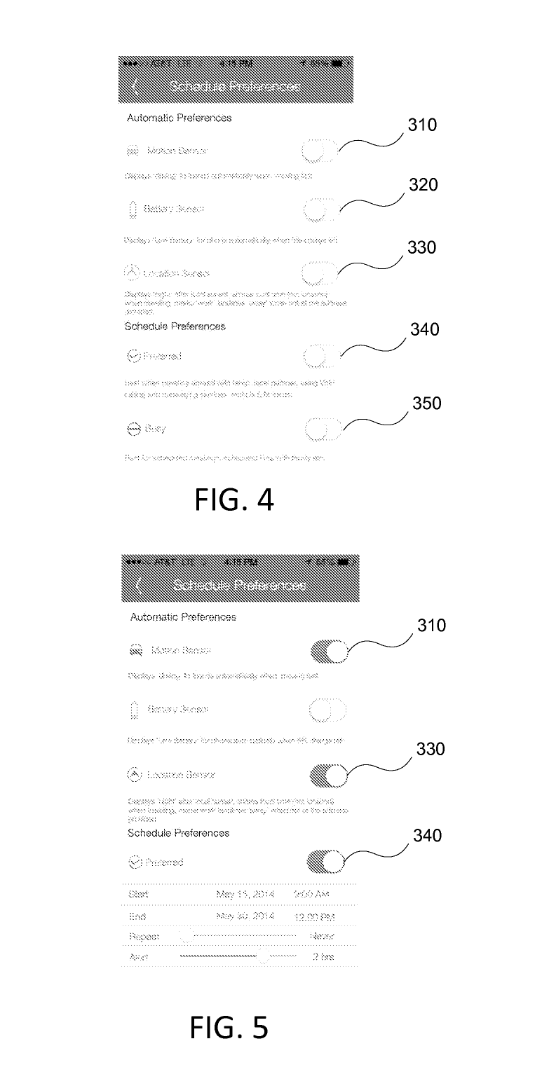

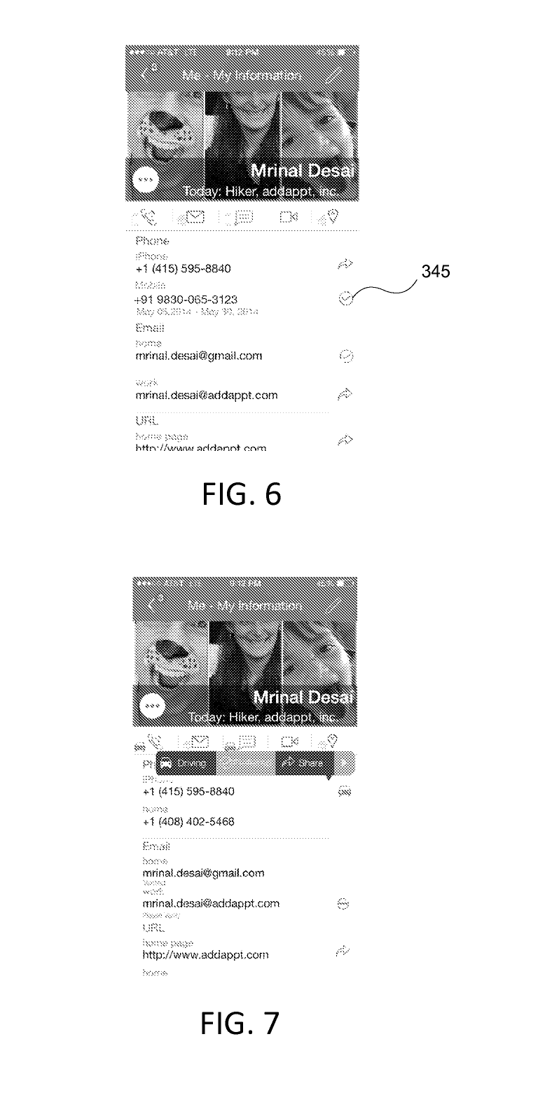

FIG. 3 shows an example screen shot of an embodiment system to schedule 240 communication preferences. By selecting the schedule button 240, a screen showing default preferences for scheduling can be shown as illustrated in FIG. 4. In FIG. 4, schedule preferences include automatic preferences for a motion sensor 310, a battery sensor 320 and a location sensor 330. For example, a motion sensor can display an icon to show a user is driving based on how fast they are going. This can in turn update the communication preferences displayed on remote devices to show that a user is driving and prefers to not be called or text messaged or that they may be contacted for emergencies or other important situations even if their preferred communication is not over that channel while they the motion sensor detects they may be driving. In another example, it may be overridden if they are riding as a passenger in a bus, car, etc.

With reference to FIG. 3, battery sensor 320 may display a low battery indicator to a remote device so a person may choose to not call them. For example, if they have a call they expect to be relatively long, they may opt not to contact the user through specific channels as their communication could be interrupted. Additionally, location sensor 330 may be used to show a local time for the user based on their time zone, a time of day or icon related to day or night based on their current location, or may change the status of certain communication channels based on being located near or distant to an address associated with that communication channel. For example, if location sensor 330 is turned on and a user is remote from their office, then their preferred communication can be updated on a remote device to show they are away from their work telephone or work email or those channels can be listed as busy, etc.

In the illustrated embodiment, schedule preferences are also listed for preferred 340 and busy 350 settings. For example, if a person is traveling in a different time zone than their home or work address, they may list a temporary local number, VoIP number, etc. as the preferred communications channel. In this way, they can schedule their preferred communications based on location, time, etc. In another example, their contact information may be set to display they are busy if they set the busy 350 setting for a scheduled meeting, for scheduled time with family or on vacation, etc.

FIG. 4 shows an example screen shot of an embodiment system to schedule communication preferences. In the screen shot the motion sensor 310 button is toggled on, the location sensor 330 button is toggled on and the preferred 340 button under scheduled preferences is toggled on. The preferred 340 button then includes a start date and time and an end date and time for the preferred communications to be scheduled. In this way a user may select to have any communication set to a preferred communication as being actively listed as a preferred communication for the scheduled time. For example, with reference to FIG. 5 a foreign number 345 is shown as the preferred communication from May 5, 2014 until May 30, 2014. Additionally, options to repeat the scheduled preference or receive alerts related to the scheduled preference are shown.

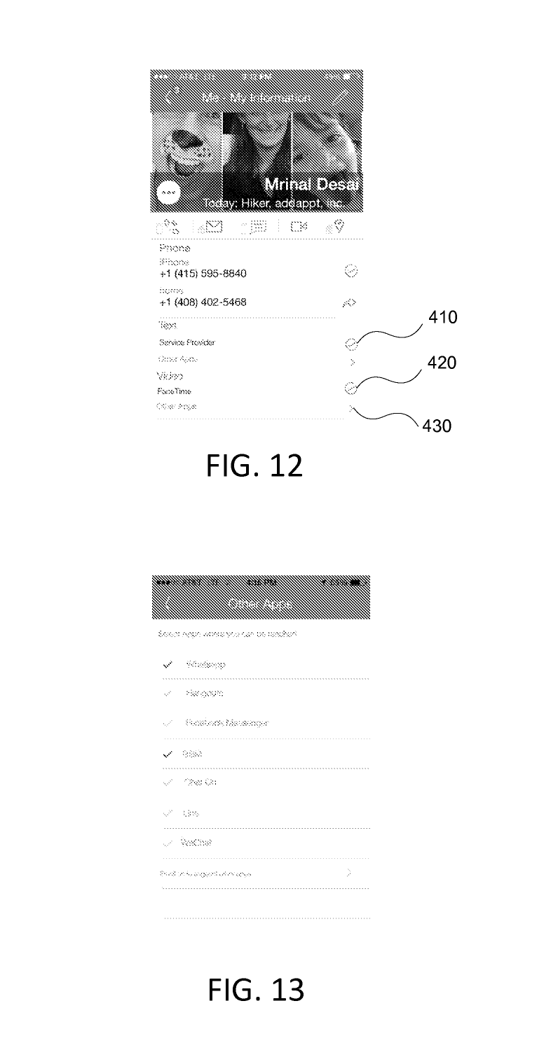

FIG. 12 shows an example screen shot of an embodiment system showing default settings for text and video communication preferences. In the current illustration, a user is provided an option to list preferred communications for a text and video, with the illustration showing the service provider 410 listed as the text preferred communication and FaceTime 420 listed as the video preferred communication. Under the text and video user selections are options to select other applications 430 as the preferred communication for that respective communication channel. FIG. 13 shows an example screen shot of an embodiment system to provide communication preferences through other applications as selected by other application option 430 in FIG. 12.

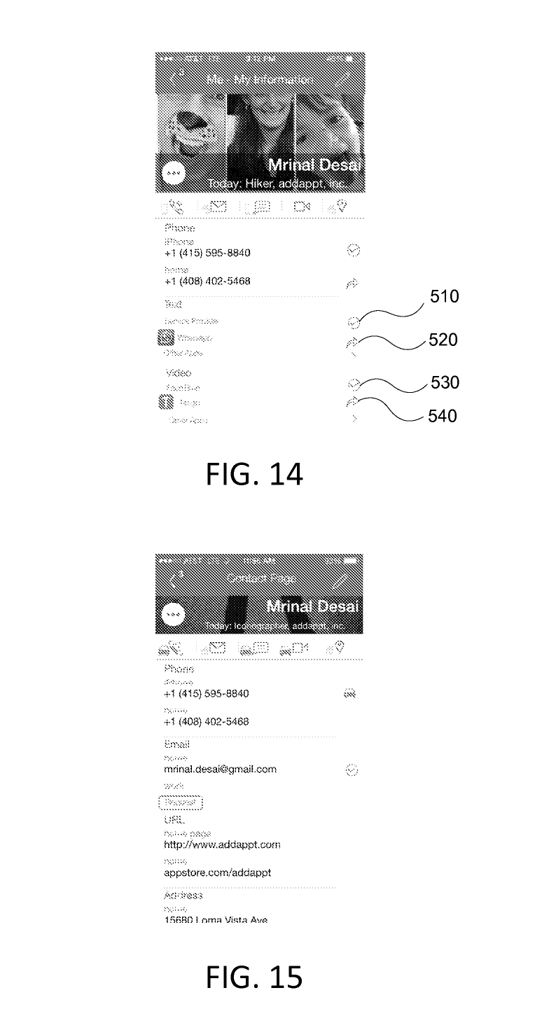

FIG. 14 shows an example screen shot of an embodiment system showing preferred and shared communication preferences for text and video. In this example screen shot, the service provider 510 and FaceTime are shown as the preferred communication for text and video, respectively, while WhatsApp 520 is shown as a shared communication channel for text applications and Tango 540 is shown is a shared communication channel for video applications. In this way a remote user may use the preferred communication channel or shared communication channel. For example, if a remote user does not have FaceTime but did have Tango, then they would choose to communicate through a video application over Tango as was shown in the shared communication.

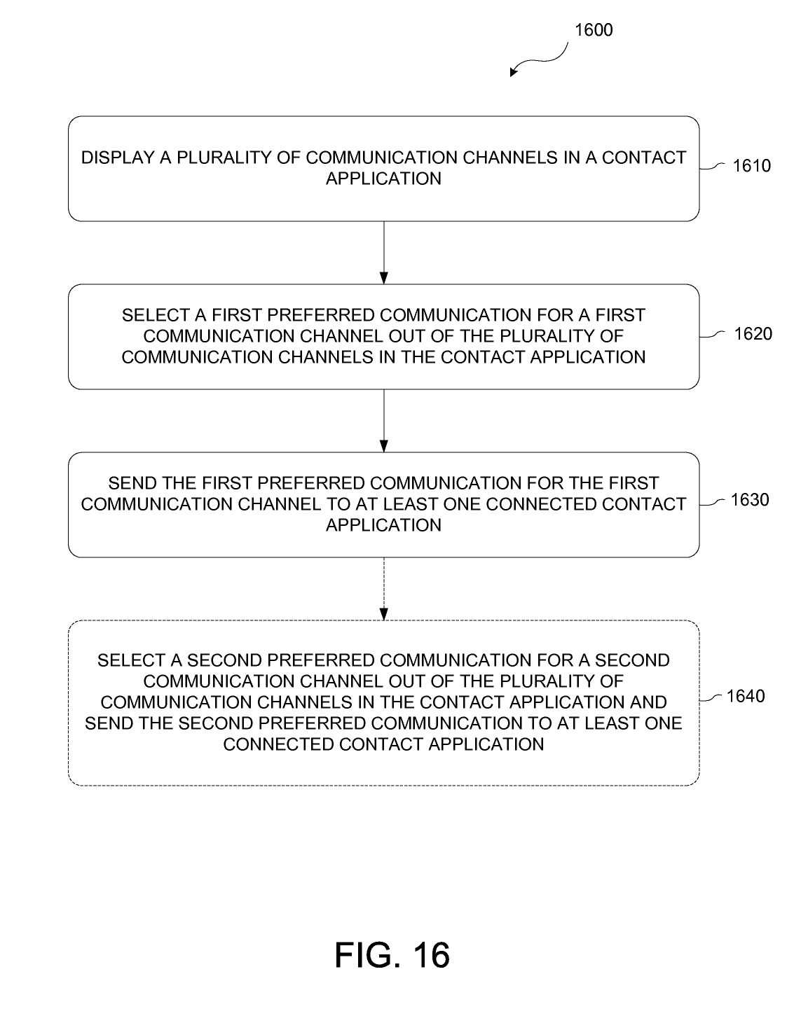

FIG. 16 shows a flow chart of one example method 1600 to set preferred communications. With reference to the figure, in block 1610 the method displays a plurality of communication channels in a contact application. In block 1620, method 1600 selects a first preferred communication for a first communication channel out of the plurality of communication channels in the contact application. As examples, the first communication channel may be at least one of a voice application, a text application and a video application. Other embodiments are not so limited and may be other communications channels. In block 1630, the contact application sends the first preferred communication for the first communication channel to at least one connected contact application.

In some embodiments, method 1600 may select a second preferred communication for a second communication channel out of the plurality of communication channels in the contact application and sending the second preferred communication to at least one connected contact application. In some embodiments, a communication may then be received on the communication channel according to a selected first preferred communication. By reference to the embodiment system above, a user may select a work email address as their preferred email out of email communication channels and then that preference can be sent to a remote connected contact application, allowing the user of that contact application to see the preferred communication over email and then send an email to that email address. Other functionality disclosed in the embodiment system above may be actively used in conjunction with or in addition to embodiment methods disclosed herein.

In some embodiments, a method may detect a location using a location service, and set a status for a communication channel based upon a location detected by the location service. Examples of status include a setting for busy, preferred, away, etc. For example, a user's location may be detected as at work and they can use a pre-set preference to show their work telephone number as their preferred phone communication when they are located there. In some embodiments their preferred communication can be adjusted based on their location showing they are not at a specific location. For example, if a user lists their work number as a preferred communication during working hours, but they are detected away from their work location then their preferred communication can be switched to their mobile telephone number. In some embodiments the user may select a hierarchy of preferred communications so that when one is not available on their first or subsequent preference their next preference could be set by the user. In some embodiments, the new preferred communication may be set automatically. In some embodiments, a preferred communication may include a preference related to a time of day or to a time zone. For example, a user may set their home email or home phone number as their preferred communication for hours that they are more likely home. In another example, if a user is travelling in a different time zone then their preferred communication can be set as their mobile number, an international phone number or a VoIP phone number, as non-limiting examples.

In some embodiments, a preferred communication may include a preference for when the user is driving. For example, a user can set a global or specific preference to show when they are driving to not receive a call or text or to not receive communications unless they are emergencies or important, etc. In this way they can reduce communications that may happen while driving by disseminating to other connected contacts their driving status and communication preferences while driving. In some embodiments this option can also be overridden, for example if the user is in transit but not driving.

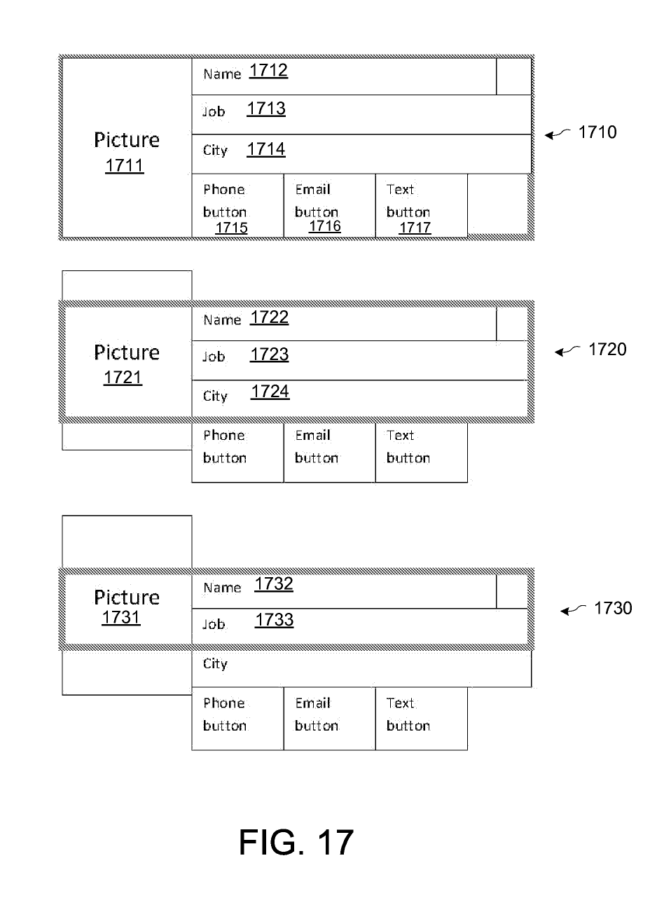

FIG. 17 shows three cell sizes for an example growing cell embodiment. In the illustrated example, a user interface can be created with a row or arrangement of cells wherein the cell dimensions or cell content that is to be displayed is based on its respective position in the user interface. For example, a first cell 1710 displaying contact information or communication preferences may have frames including a picture 1711, a name 1712, a job 1713, a city 1714, a phone button 1715, an email button 1716 and a text button 1717, where a frame is a data field represented as a separate piece of data from other frames. In other embodiments the contents or data type of each cell may be different than those depicted in FIG. 17. First cell 1710 may access a record with additional information, but in this embodiment shows the largest amount of information out of the three cells depicted in FIG. 17. In this way, this cell may be placed in a more prominent position in a user interface, such as the top cell in a row of cells, the center cell, or based on the user interface layout the cell in the position most likely to be the main focus of the user interface, etc. By way of example, a user may have multiple telephone numbers, emails, addresses, etc. In one embodiment, the first cell 1710 may include their selected communication preference for each respective communication channel. That is, a contact may list their work email as their preferred email as well as their iPhone mobile phone number. A remote user can view the first cell 1710 and upon selecting email button 1716 or the phone button 1715, their contact application would select the communication preference as selected by the contact owner and the remote device would then use the work email or call the iPhone number.

Second cell 1720 is shown with a subset of the fields of cell 1710, eliminating the phone button 1715, the email button 1716 and the text button 1717. Second cell 1720 may be adjacent to first cell 1710. In some embodiments, as a user scrolls or moves through cells displayed in the user interface, a cell may transition from a second cell to a first cell or from a first cell to a second cell, etc. This transition between cells adjusts the focal point of the user interface in a way that allows a user to recognize which data is associated with the prominently displayed cell while also showing other cells higher-level information to allow selection between cells. For example, if the cells are for separate entries in a contact book, a user may look at a larger group of contact data for a specific person while the other cells display other contacts in the contact book so the user may scan them and determine if they want to see more information than is displayed in the less prominent cells, such as second cell 1720.

In some embodiments, a third cell 1730 may be adjacent to second cell 1720 and eliminate another field. In the illustrated embodiment the eliminated field from the second cell 1720 is the city field 1714. In the illustrated embodiment the picture is successively cropped from first cell 1710 to second cell 1720, and from second cell 1720 to third cell 1730 in a manner to have the same height as the remaining fields in the cell, but other embodiments are not so limited. For example, a picture field may be smaller initially, or may change in scale but retain the full picture of first cell, etc. In some embodiments the reduction between cells may be along full fields, but in other embodiments there may be a change in the displayed area of the cell and it may more continually change size without the discrete changes based on fields of the cell. Some embodiments may have more or less categories of cells but still adjust the size or displayed content of a more prominent cell to alert a user to focus more on that cell while providing mainly high-level information to allow a more efficient selection between adjacent cells.

In some embodiments the first cell may include selectable options that are not displayed on second or third cells, etc. In this way the prominently displayed cell may also aid the user experience by removing buttons that may be inadvertently hit or that may clutter a user interface but that are shown when a cell is moved to the prominent or focused position. In some embodiments the cell may also have a different background, border, colors, etc. than the other cells to more clearly delineate it as a first cell. In the illustrated embodiment, first cell 1710 has a height of 120 points, second cell 1720 has a height of 80 points and third cell 1730 has a height of 60 points, but other embodiments may have different cell height ranges between cells.

It will further be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of any of the above-described processes is not necessarily required to achieve the features and/or results of the embodiments described herein, but is provided for ease of illustration and description.

The subject matter of the present disclosure includes all novel and nonobvious combinations and subcombinations of the various processes, systems and configurations, and other features, functions, acts, and/or properties disclosed herein, as well as any and all equivalents thereof.

1. A system to set communication preferences, comprising:
an application module including one or more applications; and
a preferred communications module including user selectable preferences, the preferred communications module further including a status component and an available channels component related to the one or more applications, wherein user selectable preferences set a status for at least one of the available channels.

2. The system of claim 1, wherein the user selectable preferences are sent to a remote device.

3. The system of claim 1, further including an applications module with an application related to one or more available channels, wherein a user may receive a communication on an available channel according to a user selectable preference.

4. The system of claim 1, wherein the applications module includes at least one of a voice application, a text application and a video application.

5. The system of claim 1, further comprising a location service, wherein a user selectable preference sets a status for an available channel based upon a location detected by the location service.

6. The system of claim 1, wherein the status component includes settings for busy and preferred.

7. The system of claim 1, wherein user selectable preferences include preferences for when the user is driving.

8. The system of claim 1, wherein user selectable preferences include preferences related to a time of day.

9. The system of claim 1, wherein the user selectable preferences include preferences related to a time zone.

10. The system of claim 1, further including inferred preferences that set a communication preference based upon a detected condition without requiring a user selection.

11. A method comprising:
displaying a plurality of communication channels in a contact application;
selecting a first preferred communication for a first communication channel out of the plurality of communication channels in the contact application; and
the contact application sending the first preferred communication for the first communication channel to at least one connected contact application;

12. The method of claim 11, further comprising selecting a second preferred communication for a second communication channel out of the plurality of communication channels in the contact application and sending the second preferred communication to at least one connected contact application.

13. The method of claim 11, further comprising receiving a communication on the communication channel according to a selected first preferred communication.

14. The method of claim 11, wherein the first communication channel is at least one of a voice application, a text application and a video application.

15. The method of claim 11, further comprising detecting a location using a location service, and setting a status for a communication channel based upon a location detected by the location service.

16. The method of claim 15, wherein the status includes a setting for busy or preferred.

17. The method of claim 11, wherein the first preferred communication includes a preference for when the user is driving.

18. The method of claim 11, wherein the first preferred communication includes a preference related to a time of day.

19. The method of claim 11, wherein the first preferred communication includes a preference related to a time zone.

20. The method of claim 11, further including setting an inferred communication preference based upon a detected condition without requiring a user selection.
